(19) United States
(12) Patent Application Publication
(10) Pub. No.: US 2022/0027720 A1
(43) Pub. Date: Jan. 27, 2022

(54) METHOD TO PARAMETERIZE A 3D MODEL

(71) Applicant: Ilya LYSENKOV, Nizhny Novgorod (RU)

(72) Inventor: Ilya LYSENKOV, Nizhny Novgorod (RU)

(73) Assignee: Itseez3D, Inc., Santa Clara, CA (US)

(21) Appl. No.: 16/935,434

(22) Filed: Jul. 22, 2020

(51) Int. Cl. G06N 3/08; G06T 7/00; G06T 15/04; G06T 17/20

(52) U.S. Cl. CPC G06N 3/08; G06T 7/0012; G06T 15/04; G06T 2207/30201; G06T 2207/20084; G06T 2207/20081; G06T 17/20

(57) ABSTRACT

The present invention provides a method to produce a 3D model of a person or an object from just one or several image. The method uses a neural network that is trained on pairs of 3D models of human heads and their frontal images, and then, given an image, infers a 3D model.

### BACKGROUND OF THE INVENTION

### Field of Invention

The present invention relates to a method of creating a 3D model of a human from a single image. The core of the invention is a new way of parameterization of a 3D model and representing the parameterized 3D model of a person as two images: one for geometry and one for texture. These images can be used with deep neural networks, which allows to use 3D models in deep learning pipelines as an input, an output, or an intermediate representation.

### Description of the Related Art

The present invention is directed to solving the problem of 3D face reconstruction from image(s). Solution of this problem has useful applications in various fields, such as virtual reality/augmented reality, e-commerce, video games, social messengers, 3D printing and more. With success of deep learning, it is natural to try to solve this problem using neural networks, where an image(s) of a face is passed as input to a neural network, and this neural network generates a 3D model of this face as output. However, neural networks are suitable for working with images, but it is challenging to use 3D models in neural networks.

Our U.S. patent application Ser. No. 16/426,127 [1] addresses this problem by creating a mapping from a 3D model to several images that can be used with neural networks. The content of U.S. patent application Ser. No. 16/426,127 [1] is hereby incorporated by reference. This method can be applied to monocular 3D face reconstruction (which is our primary focus) as well as the reconstruction of other types of objects, such as full body models, furniture and buildings. The same method can be utilized in all other tasks where there is need to use 3D models with neural networks. However, the method disclosed in U.S. patent application Ser. No. 16/426,127 has drawbacks. The parameterization of the method cannot fully describe long hair, shoulders, inside sides of collars.

Example of this is shown in FIG. 1, 2, 3 of the present application. The left images in these figures represent the original 3D model, the central images represent the model mapped to images using the method disclosed in U.S. patent application Ser. No. 16/426,127 and then mapped back to 3D, the right image shows the model mapped to images with the method disclosed in the present invention and then mapped back to 3D. FIG. 1 shows 3D model renderings with texture, FIG. 2—only shape, FIG. 3—only vertices of the 3D model. One can see that the method [1] results in a poor representation of shoulders and the inside part of the collar. You can see unpleasant jagged artifacts in these areas in FIG. 1 and FIG. 2, while FIG. 3 shows that the method disclosed in U.S. patent application Ser. No. 16/426,127 doesn't produce points in these areas, so it cannot represent either shape or texture. However, the method in the present application gives good smooth surface in the same areas. Overcoming the issues such as shown in FIG. 1, 2, 3 was the primary motivation for creating this invention.

There is a vast field of research in the computer graphics community as to how to parameterize a 3D model (see [2] for a review), however, it is aimed to minimize distortions after unwrapping and suitability for neural network is not a concern. For example, it helps neural networks when representations of 3D models are consistent across models, i.e. the same semantic parts (e.g. eye, ear, neck, etc.) in different models are located in roughly the same area in parametrizations, but this is not addressed in prior work in parameterizations for graphics.

A parameterization specific for faces and which was used with neural networks was proposed in [3]. However, their method is only applicable to faces and cannot be applied to the full head with hair, shoulders and back, unlike our method.

A related idea is to use displacement maps to model geometry (e.g. [4]), however, it requires a template model (and our method doesn't), and this representation cannot represent complex geometry, e.g. long hair (and our method can).

Other attempts to create parameterizations of 3D models that are suitable to use with neural networks are [5, 6]. Our parameterization has the advantage that the produced textures are aligned well with frontal view of a 3D model, e.g. the left eye in the frontal render and the left eye in the texture have close pixels coordinates. This is important when using both frontal images and textures in the deep learning pipeline, e.g. if one wants to give a frontal image as the network input and get the 3D model as the network output. The methods [5, 6] don't have such alignment, which means that to generate features of the left eye, the neural network has to process features from a distant part of an image. This is challenging for convolutional neural networks due to limited receptive fields of neurons, and our method doesn't have this problem.

### SUMMARY OF THE INVENTION

The present invention represents a 3D model as two images Iₛ and Iₜ (Iₛ describes model shape, and Iₜ describes texture). For simplicity we assume they have the same resolution H×W (e.g. we've used 512×512). For each pixel in this H×W grid we find the corresponding point on the 3D model surface (we'll describe in detail how to do this below). After we've found such points for all pixels, we can construct the images Iₛ and Iₜ representing the 3D model: each pixel of the shape image Iₛ will store 3 floating-point coordinates (for example, Cartesian coordinates x, y, z) of the corresponding 3D point on the surface of the 3D model, and the same pixel in the texture image Iₜ will store RGB colors of this corresponding 3D point.

[1] suggests a correspondence between pixels and 3D points by plotting rays from the vertical axis (directed from the body to the top of the head for a human 3D model) in all directions, so that the angles between neighboring rays are the same (see more details in [1]). This mapping does not depend on a 3D model, and for some 3D models it produces issues: if a 3D model has somewhat complex shape, e.g. it has collars or long hair, then mapping has to be updated to place more points in these areas. FIG. 3 gives an example of this. The central image shows mapping produced with [1], and one can see it didn't have enough points on collar and shoulders for this particular model, however, the method proposed in this invention adapts the mapping for this model and places more points in these areas (as shown in FIG. 3 on the right).

In summary the present invention is directed to the following.

A method of neural network learning of 3D models of human heads comprising the steps of:

a) providing at least two training 3D models produced by scanning or modeling representative human heads;
b) mapping each training 3D model to a pair of target images comprising an Iₛ image that describes the model shape, and an Iₜ image that describes the model texture;
c) parameterizing each 3D model by representing each of the 3D model as a standard triangulated mesh, establishing a correspondence map between each 3D model and the Iₛ image by using the correspondence of each pixel of Iₛ within the standard triangulated mesh to a 3D point p on the surface of the 3D model, and optimizing the cost function to produce a mapping between each 3D model and Iₛ image;
d) rendering a frontal image of each parameterized 3D model, detecting facial features in the frontal images, and applying a 2D affine transformation to the frontal images in order to make the coordinates of the facial features as close to the average position of facial features for all the parameterized 3D models to produce frontal images of the representative heads;
e) training a deep learning network on the pair of target images Iₛ and Iₜ, and the frontal images of the representative human heads; and
f) using the trained deep learning network to predict the target images Iₛ and Iₜ from an input image that contains a frontal photo of a human head.

The method of neural network learning of 3D models of human heads as discussed above may have a step b) that comprises

i) placing each of the training 3D model of a human head in the standard orientation into a reference surface, wherein the reference surface consists of a cylinder and a half-sphere, the cylinder axis coinciding with the z axis, the cylinder upper plane being placed on the level of a forehead of training 3D model, and the half-sphere placed on top of the cylinder upper plane; and the standard orientation is the training 3D model orientation with a line between the eyes parallel to x axis, the line of sight parallel to y axis, and z axis going from the approximate center of the neck up to the top of the head;
ii) for points with z coordinate smaller than or equal to the upper cylinder plane, producing a cylindrical projection to establish the correspondence between the human head and the reference surface;
iii) for points with z coordinate larger than the cylinder upper plane, producing a spherical projection to establish the correspondence between the human head and the reference surface; and
iv) defining a distance r for each point from the human head as a distance from a point from the human head to the cylinder axis for points lower than or equal to the cylinder upper plane, and as a distance from a point from the human head to the half-sphere center for points above the cylinder upper plane.

The method of step b) as discussed above may further comprise:

v) mapping the lower part of the images Iₛ and Iₜ to the cylinder, with x coordinates of image pixels linearly mapped to the azimuthal angle of the cylinder points, and y coordinates of image pixels linearly mapped to the z coordinate of the cylinder points;
vi) mapping the upper part of the images Iₛ and Iₜ to the half-sphere, with x coordinate of image pixels linearly mapped to the azimuthal angle of the half-sphere points, and y coordinate of image pixels linearly mapped to the polar angle of the half-sphere points.

The method of neural network learning of 3D models of human heads may have a step c) wherein the cost function comprises the sum of the squares of distances between all 3D points p(u, v) and p(i,j), where (u, v) are coordinates of any pixel in the image Iₛ, p(u, v) is a 3D point that corresponds to the pixel (u, v) and lies on the surface of a 3D model, and (i, j) are coordinates of a pixel neighboring to the pixel (u, v), p(i,j) is a 3D point that corresponds to the pixel (i, j) and lies on the surface of a 3D model.

In the method of neural network learning of 3D models of human heads, wherein in step c) comprises for each 3D point p(u, v) finding a triangle or quadrangle to which the point p(u, v) belongs and compute barycentric coordinates of the 3D point p(u, v) in the triangle or quadrangle and optimizing the cost function with regards to the barycentric coordinates to produce a mapping between each 3D model and Iₛ image. The optimizing of the cost function with regards to the barycentric coordinates may comprise using the Levenberg-Marquardt algorithm.

### BRIEF DESCRIPTION OF THE DRAWINGS

In the drawings:

FIG. 1 shows 3D model renderings with texture

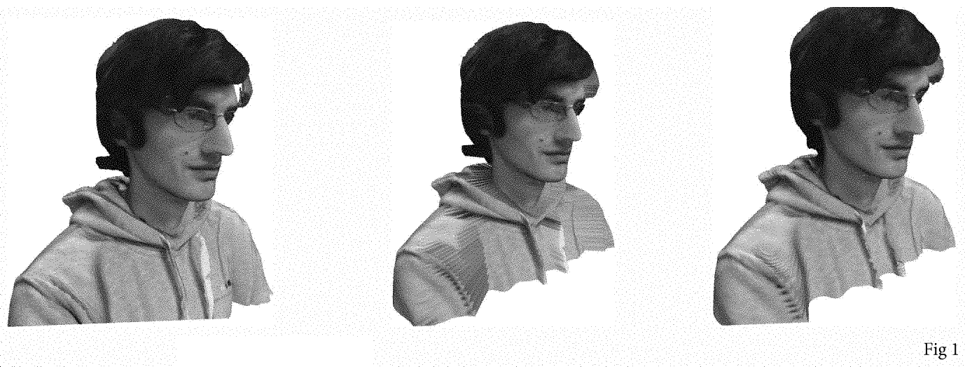

FIG. 2 shows 3D model renderings with only shape

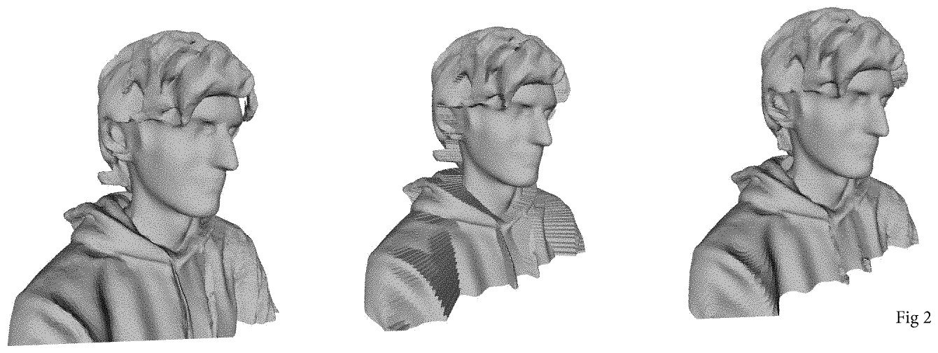

FIG. 3 shows 3D model renderings with only vertices

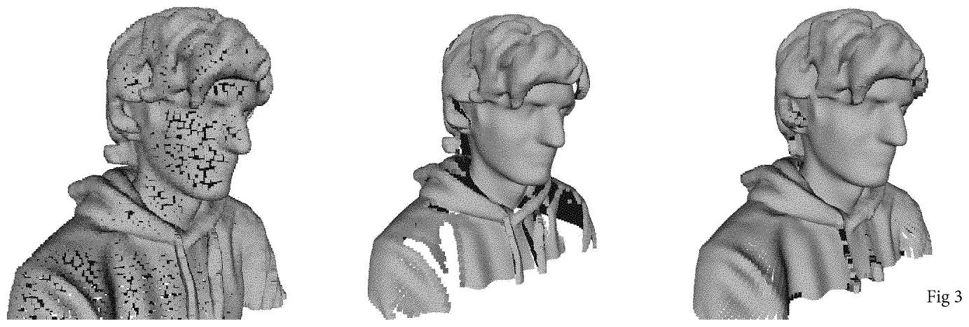

FIG. 4 shows in the left image the original 3D model shape, in the middle image the parameterized model without these terms, and on the right image the model parameterized with these terms.

FIG. 5 shows an example of a produced shape image

FIG. 6 shows an example of a produced texture image

### DETAILED DESCRIPTION OF THE PRESENTLY PREFERRED EMBODIMENTS

This invention proposes a mapping that depends on a 3D model. For each 3D model we find these corresponding 3D points by solving an optimization problem that contains five terms:

$${min}_{p ∈ surface} {\sum }_{u = 0}^{H - 1} {\sum }_{v = 0}^{W - 1} {\sum }_{i , j ∈ N ( u , v )} {‖ p ( u , v ) - p ( i , j ) ‖}^{2} + {α ( \vec{n} ( p ( u , v ) ) \cdot ( p ( u , v ) - p ( i , j ) ) )}^{2} + {α ( \vec{n} ( ( i , j ) ) \cdot ( p ( u , v ) - p ( i , j ) ) )}^{2} + β {\sum }_{v = 0}^{W - 1} {‖ p ( 0 , v ) - T ‖}^{2} + γ {\sum }_{v = 0}^{W - 1} {\vert {p}_{z} ( H - 1 , v ) - Z \vert}^{2} ,$$

where (u, v) are coordinates of a pixel, p(u, v)—a 3D point that corresponds to the pixel (u, v) and lies on the surface of a 3D model, \vec{n}(p(u, v))—a normal of the 3D model at the point p(u, v), N(u, v) is a set of coordinates of pixels in the (u, v) neighborhood (we've used 4-neighborhood, that is N(u, v) contains the pixels directly above, directly below, on the left and on the right to pixel (u, v), if they exist), α, β, γ—the weights for the terms in the cost function (we've used value 2.0 for α, 2.0 for β and 100.0 for γ). We align 3D models of people as in [1], so that z-axis is oriented from the (approximately) center of the neck up to the top of the head. T is the intersection point between z-axis and top of the head, Z is the lowest z-coordinate on the person's body that we want to model (in our experiments we set it approximately to the middle of the chest), p_{z}(u, v)—z-coordinate of the point p(u, v).

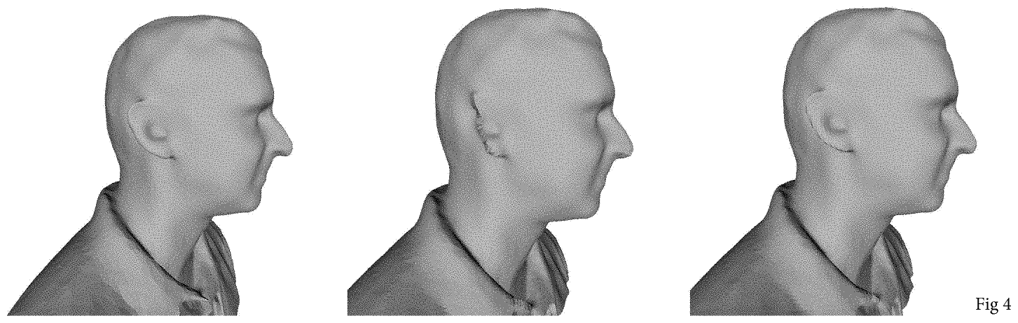

The parameterization should represent all surface of a model, this is achieved when the corresponding 3D points sample the surface model densely without big gaps, close to each other. This effect is produced by the first term in the cost function: it requires that 3D points, corresponding to neighboring pixels, are close to each other in 3D. The second and the third term are not critical, but they give better preservation of edges of the surface by preserving surface normal. An example is shown in FIG. 4: the left image shows the original 3D model shape, the middle—the parameterized model without these terms, and on the right is the model parameterized with these terms. One can note by looking at the middle image that if the second and third terms are not used, ears get cropped and shape of nose slightly deteriorates. The fourth and the fifth terms prevent the collapse of all points into a single location and serve as boundary conditions. These boundary conditions can have different form as long as they prevent all the points from collapsing, e.g. instead one can just explicitly set 3D points, corresponding to boundary pixels in the parameterization image, to be on the model boundary or model extrema.

We solve this optimization problem with iterative optimization. We start with initializing points p as the points in the cylinder with half-sphere parameterization [1]. Also, we need to take into account that points p must belong to the surface of the 3D model. To resolve this, we represent the 3D model as a standard triangulated mesh, and then for each point p we find a triangle to which it belongs and compute barycentric coordinates of the point p in this triangle. Then we optimize the cost function with regards to these barycentric coordinates, instead of coordinates of the point p, using Levenberg-Marquardt algorithm [7, 8]. If after a step of the Levenberg-Marquardt algorithm the point p has moved outside of its triangle, then we find the closest point to it on the mesh, its triangle, compute barycentric coordinates of this point in this triangle and move the point p to that point. Using this algorithm, we can ensure that points p lie on the surface of the 3D model, and at the same time keep the optimization problem tractable. To speed up optimization and improve convergence, we solve the optimization problem on 256×256 resolution images, then upscale the solution to 512×512 resolution and refine it by running optimization on this resolution.

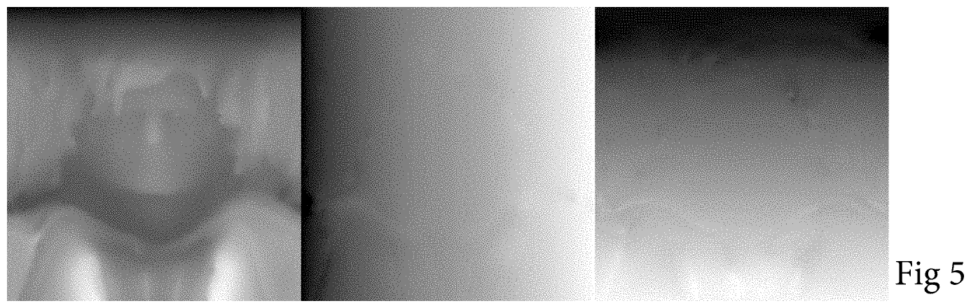

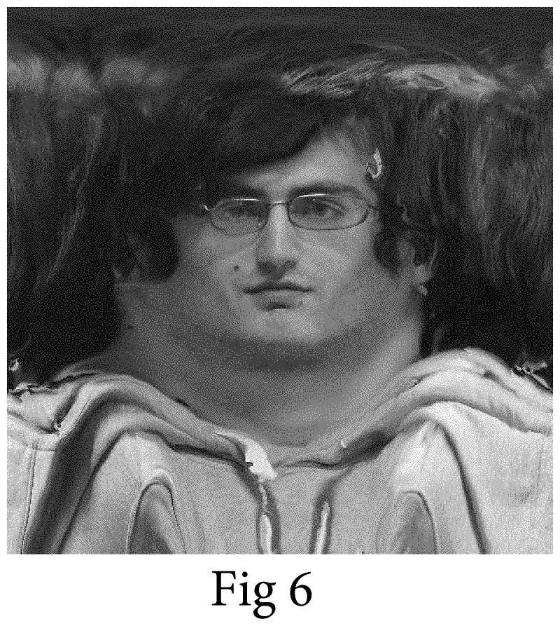

Once we have solved the optimization problem and obtained the mapping p(u, v), we can map a 3D model to a pair of two images: shape and texture. A 3-channel shape image will store 3 coordinates p(u, v) in a pixel with coordinates (u, v). It can be Cartesian coordinates (x, y, z) or any other coordinates defining a point in 3D space. In our experiments we used the cylindrical coordinate system (r, φ, h) with the axis along z-axis (r is the distance to the axis, φ is azimuth angle, h is the coordinate along the z-axis). An example of a produced shape image Iₛ is shown in FIG. 5. For better visualization instead of stacking the coordinates along the channels dimension, we stack them along horizontal axis, so one can see each channel of cylindrical coordinates individually: the images from left to right show r, φ, h coordinates correspondingly. The 3-channel texture image will store color of the point p(u, v) in the pixel (u, v). An example of a produced texture image Iₜ is shown in FIG. 6.

The reverse mapping from a pair of images to a 3D model is quite straightforward. We reconstruct 3D points from pixels using the mapping p(u, v) from the shape image, then connect the points corresponding to neighboring pixels into triangles or quadrangles. The texture image is used for texture, with a UV map built from the mapping p(u, v).

This representation has important properties that allow it to be used with neural networks:
1. The 3D model is represented as two continuous images,
2. These images are aligned with each other (meaning that when a pixel (u, v) from the shape image Iₛ stores 3D coordinates of a point in the shape image, the pixel (u, v) in the texture image Iₜ stores the color of the same 3D point),
3. The 3D model is not distorted much in these images, and also these images are mostly consistent from one model to another (e.g. location of a left eye in these images in one model, would be roughly in the same area where the left eye is located in another model).

We've successfully used this parameterization to train a neural network which takes a selfie as input and produces a 3D model of the head with shoulders as output. Also, this parameterization can be used in many other applications where one needs to use 3D models with neural networks.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### REFERENCES

[1] Lysenkov, Ilya. A method to produce 3D model from one or several images, patent application Ser. No. 16/426,127.
[2] Sheffer, A., Praun, E., & Rose, K. (2007). Mesh parameterization methods and their applications. Foundations and Trends® in Computer Graphics and Vision, 2(2), 105-171.
[3] Feng, Y., Wu, F., Shao, X., Wang, Y., & Zhou, X. (2018). Joint 3D Face Reconstruction and Dense Alignment with Position Map Regression Network. arXiv preprint arXiv:1803.07835.
[4] Lazova, V., Insafutdinov, El., & Pons-Moll, G (2019). 360-Degree Textures of People in Clothing from a Single Image. In International Conference on 3D Vision (3DV) (pp. 643-653).
[5] Sinha, A., Bai, J., & Ramani, K. (2016, October). Deep learning 3D shape surfaces using geometry images. In European Conference on Computer Vision (pp. 223-240). Springer, Cham.
[6] Pumarola, A., Sanchez-Riera, J., Choi, G., Sanfeliu, A., & Moreno-Noguer, F. (2019). 3DPeople: Modeling the geometry of dressed humans. In Proceedings of the IEEE International Conference on Computer Vision (pp. 2242-2251).
[7] Levenberg, Kenneth (1944). “A Method for the Solution of Certain Non-Linear Problems in Least Squares”. Quarterly of Applied Mathematics. 2 (2): 164-168.
[8] Marquardt, Donald (1963). “An Algorithm for Least-Squares Estimation of Nonlinear Parameters”. SIAM Journal on Applied Mathematics. 11 (2): 431-441.

1. A method of neural network learning of 3D models of human heads comprising the steps of:
a) providing at least two training 3D models produced by scanning or modeling representative human heads;
b) mapping each training 3D model to a pair of target images comprising an Iₛ image that describes the model shape, and an Iₜ image that describes the model texture;
c) parameterizing each 3D model by representing each of the 3D model as a standard triangulated mesh, establishing a correspondence map between each 3D model and the Iₛ image by using the correspondence of each pixel of Iₛ within the standard triangulated mesh to a 3D point p on the surface of the 3D model, and optimizing the cost function to produce a mapping between each 3D model and Iₛ image;
d) rendering a frontal image of each parameterized 3D model, detecting facial features in the frontal images, and applying a 2D affine transformation to the frontal images in order to make the coordinates of the facial features as close to the average position of facial features for all the parameterized 3D models to produce frontal images of the representative heads;
e) training a deep learning network on the pair of target images Iₛ and Iₜ, and the frontal images of the representative human heads; and
f) using the trained deep learning network to predict the target images Iₛ and Iₜ from an input image that contains a frontal photo of a human head.

2. The method of claim 1 wherein step b) comprises
i) placing each of the training 3D model of a human head in the standard orientation into a reference surface, wherein the reference surface consists of a cylinder and a half-sphere, the cylinder axis coinciding with the z axis, the cylinder upper plane being placed on the level of a forehead of training 3D model, and the half-sphere placed on top of the cylinder upper plane; and the standard orientation is the training 3D model orientation with a line between the eyes parallel to x axis, the line of sight parallel to y axis, and z axis going from the approximate center of the neck up to the top of the head;
ii) for points with z coordinate smaller than or equal to the upper cylinder plane, producing a cylindrical projection to establish the correspondence between the human head and the reference surface;
iii) for points with z coordinate larger than the cylinder upper plane, producing a spherical projection to establish the correspondence between the human head and the reference surface; and
iv) defining a distance r for each point from the human head as a distance from a point from the human head to the cylinder axis for points lower than or equal to the cylinder upper plane, and as a distance from a point from the human head to the half-sphere center for points above the cylinder upper plane.

3. The method of claim 2 wherein step b) further comprises:
v) mapping the lower part of the images Iₛ and Iₜ to the cylinder, with x coordinates of image pixels linearly mapped to the azimuthal angle of the cylinder points, and y coordinates of image pixels linearly mapped to the z coordinate of the cylinder points;
vi) mapping the upper part of the images Iₛ and Iₜ to the half-sphere, with x coordinate of image pixels linearly mapped to the azimuthal angle of the half-sphere points, and y coordinate of image pixels linearly mapped to the polar angle of the half-sphere points.

4. The method of claim 1 wherein in step c) the cost function comprises the sum of the squares of distances between all 3D points p(u, v) and p(i,j), where (u, v) are coordinates of any pixel in the image Iₛ, p(u, v) is a 3D point that corresponds to the pixel (u, v) and lies on the surface of a 3D model, and (i, j) are coordinates of a pixel neighboring to the pixel (u, v), p(i,j) is a 3D point that corresponds to the pixel (i, j) and lies on the surface of a 3D model.

5. The method of claim 4 wherein for each 3D point p(u, v) finding a triangle or quadrangle to which the point p(u, v) belongs and compute barycentric coordinates of the 3D point p(u, v) in the triangle or quadrangle and optimizing the cost function with regards to the barycentric coordinates to produce a mapping between each 3D model and Iₛ image.

6. The method of claim 5 wherein the optimizing of the cost function with regards to the barycentric coordinates comprises using the Levenberg-Marquardt algorithm.
